(19) United States
(12) Patent Application Publication
(10) Pub. No.: US 2017/0274305 A1
(43) Pub. Date: Sep. 28, 2017

(54) WASTEWATER TREATMENT APPARATUS AND SYSTEM FOR OIL AND GAS PRODUCTION WELLS

(71) Applicant: Logic Energy Solutions, LLC, Oklahoma City, OK (US)

(72) Inventors: John W. Moore, III, Oklahoma City, OK (US); Devon S. Dupree, Butler, OK (US); Kevin G. Gentry, Oklahoma City, OK (US); Roger P. Boulter, Harlingen, TX (US)

(21) Appl. No.: 15/621,101

(22) Filed: Jun. 13, 2017

Related U.S. Application Data
(63) Continuation of application No. 14/512,531, filed on Oct. 13, 2014, now abandoned.
(60) Provisional application No. 61/961,462, filed on Oct. 15, 2013.

(51) Int. Cl. B01D 36/00; B01D 1/00

(52) U.S. Cl. CPC B01D 36/001; B01D 1/0094; B01D 1/0058; C02F 2103/10

(57) ABSTRACT

The present invention comprises a closed loop system for the removal of contaminants from wastewater while evaporating the water by utilizing a continuously running evaporator in communication with a separation tank wherein water is returned to the evaporator and solids are left in the separation tank for disposal.

### CROSS-REFERENCE TO RELATED APPLICATIONS

Priority is claimed from provisional patent application U.S. Ser. No. 61/961,462 filed on Oct. 15, 2013 and incorporated by reference herein.

### BACKGROUND OF THE INVENTION

1. Field of the Invention

In general, the present invention relates to an apparatus, system and method of evaporating and or treating wastewater associated with well operations. More particularly, the present invention provides a closed loop system for the removal of contaminants from wastewater while evaporating the water by utilizing a continuously running evaporator in communication with a separation tank wherein water is returned to the evaporator and solids are left in the separation tank for disposal.

2. Description of the Prior Art

In the oil and gas industry, a major concern facing the field is the ever growing and constant concern with environmental impact of oil and gas production coupled with the ever-increasing need to maximize efficiency and recovery. Prior art methods that were perfectly acceptable just years ago are now politically and environmentally unfriendly as well as wasteful in hindsight. Whereas, it was acceptable to allow by products from well production to be released into the environment, it is not considered a viable economic or environmentally sound method to date.

It is known to treat the wastewater for general reuse and return to the environment although the amount of wastewater to be treated and cost of treating can be prohibitive. It is also known to evaporate the wastewater or large percentage of such thereby reducing the amount of water left to be treated and or returned to the environment. Evaporation is often preferred because of its generally light footprint on the environment when emissions are controlled and the operation cost of the massive evaporation is not prohibitive.

Submerged combustion heating is generally a method whereby hot products of combustion are forced through a liquid or liquid-solid mixture to heat the liquid or liquid-solid mixture. An advantage of this heating system is that the heat exchange occurs directly between the hot gaseous products of combustion and the liquid. In a submerged combustion system, the hot combustion is typically fuelled by a combination of air and natural gas. Another benefit of such application is the natural gas needed to fuel the evaporation may come from the well operation thereby eliminating the need for transporting a fuel.

The operational benefits of evaporation are reduced handling of produced water, which streamlines the entire operation; fewer trucks needed to move the wastewater mean less site damage, maintenance and general reduced liability; and overall less dependence on water haulers eliminates scheduling delays and fees. The environmental benefits include less CO2 emissions as the need for trucks is reduced and or eliminated as well as less road damage and noise associated with fewer trucks. Other benefits may be reduced flaring, improved public perception of evaporation versus injection, and less likelihood of spills or surface water contamination.

Large-scale evaporation of significant amounts of wastewater does create challenges. In a desalination process, salts, minerals and other various dissolved and suspended solids are separated from the water. In a thermal process, as the influent water is heated, the dissolved solids become concentrated, increase in weight, and turn into suspended solids. After the dissolved solids become suspended, the concentrated solids fall to the bottom of the tank in which the heat treating occurs, while the free water moves towards the top of the tank in the form of a vapor. The vapor then exits the tank through an opening, most commonly referred to as a stack or an exhaust. To continue the desalination process, the solids eventually must be removed from the treating tank.

In the prior art, as with a submerged combustion system, the operation must typically be shut down to remove the accumulated solids at the bottom of the tank. This obviously requires time for the shut-down process, the emptying of the waste out of the evaporator, and the start up again of the combustion system. This can lead to a significant down time, which also means that well operations can be affected.

It is therefore desirable to provide a means to handle the accumulated solids from water evaporation systems such as but not limited to submerged combustion applications that allow the continuous operation of the evaporation process without the need to shut down same to remove the accumulated solids. The balance of cost, time and operational efficiency has created a need for new and improved treatment systems for wastewater. The above discussed limitations in the prior art is not exhaustive. Thus, there is a need for an apparatus, method and system to separate the components from wastewater utilized well production that maximizes efficiency and is environmentally friendly. The current invention provides an inexpensive, time saving, more reliable apparatus, system and method where the prior art fails.

### SUMMARY OF THE INVENTION

In view of the foregoing disadvantages inherent in the known types of wastewater treatment associated with well operations now present in the prior art, the present invention provides a new and improved wastewater separation apparatus, system and method of use, which may also be removably positioned to oil and gas wells. As such, the general purpose of the present invention, which will be described subsequently in greater detail, is to provide a new and improved wastewater treatment application which has all the advantages of the prior art devices and none of the disadvantages.

To attain this, the present invention essentially comprises a closed loop system that generally utilizes a pump in communication with an evaporating treating tank discharge wherein the suction end of the pump is connected to an opening on the bottom of an evaporator and or treating tank; a line then connects the discharge of the pump to the inlet opening of a separation tank; and a line then connects to the outlet opening of the separation tank back to an opening in the evaporator and or evaporator holding tank. As the solids fall to the bottom of the treating tank, they enter into the suction end of the pump and are discharged to the separation tank via a pipe or hose. The separation tank uses the properties of gravity, cooling and time to separate the suspended solids from the free water. As the solution cycles through the separation tank, the suspended solids fall to the bottom of the tank, while the free liquid floats across the top. The free water then exits the separation tank through an outlet opening and returns to the treating tank via a hose or pipe. Over time, the separation tank fills up with solids and is then emptied as desired while leaving the evaporator to remain operational.

The current invention may be utilized in fracking operations, well production in general, drilling operations, permanent placement at the well and so forth. It is also understood the current invention may be utilized in other applications where it is desirable to separate solids from liquids other than oil and gas applications.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Therefore, it is an object of the present invention to provide a new and improved wastewater treatment application with a separator and method of using the same, which may be easily and efficiently utilized.

It is a further object of the present invention to provide a new and improved wastewater treatment application with a separator and method, which is of a durable and reliable construction and may be utilized with multiple wells.

An even further object of the present invention is to provide a new and improved wastewater treatment application with a separator and method, which is susceptible to a low cost of manufacture with regard to both materials and labor, and which accordingly is then susceptible to low prices of sale to the consuming industry, thereby making such tool economically available to those in the field.

Still another object of the present invention is to provide a new and improved wastewater treatment application with a separator and method, which provides all of the advantages of the prior art, while simultaneously overcoming some of the disadvantages normally associated therewith.

Another object of the present invention is to provide a new and improved wastewater treatment application with a separator and method, which maximizes evaporation of water and concentrates solids for disposal, creates an opportunity for beneficial use of reclaimed solids and or reduces waste volume and weight through dewatering.

Yet another object of the present invention is to provide a new and improved wastewater treatment application with a separator and method that may be generally mobile, may be moved from site to site with existing transportation equipment and provides efficient and effective loading, offloading and transportation in general.

An even further object of the present invention is to provide a new and improved wastewater treatment application with a separator and method, which improves the evaporation process in general, is environmentally friendly and provides the opportunity to reuse condensed water.

Still another object of the present invention is to provide a new and improved wastewater treatment application with a separator and method, which reduces risky, high-cost handling; increases production through shut-down avoidance; and improves cost management predictability.

Yet still another object of the present invention is to provide a new and improved wastewater treatment application with a separator and method, which may be utilized in aspects of oil and gas operations as well as other applications where it is desirable to remove solids from wastewater or water in general.

Still another object of the present invention is to provide a new and improved wastewater treatment application with a separator and method, which has a small foot print as well as ease of start-up.

A further object of the present invention is to provide a new and improved wastewater treatment application with a separator and method that dewaters solids optimally thereby able to pass the paint filter test and qualifying waste solids for landfill disposal, prevents hardening and solidification of the solids to a level that would prevent easy offload at the landfill and provides a consistency of solids combined with separation container design making disposing of solids quick and efficient.

An even further object of the present invention is to provide a new and improved wastewater treatment application with a separator and method that generally has one moving part associated with the separator thereby making downtime minimal, reducing maintenance and providing a safe operation.

These, together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE PICTORIAL ILLUSTRATIONS, GRAPHS, DRAWINGS AND APPENDICES

The invention will be better understood and objects other than those set forth above will become apparent when consideration is given to the following detailed description thereof. Such description makes reference to the annexed pictorial illustrations, graphs, drawings and appendices wherein:

FIG. 1 is a general illustration of a preferred embodiment of the invention.

FIG. 2 is general illustration of a preferred embodiment of the invention but not depicting an evaporator.

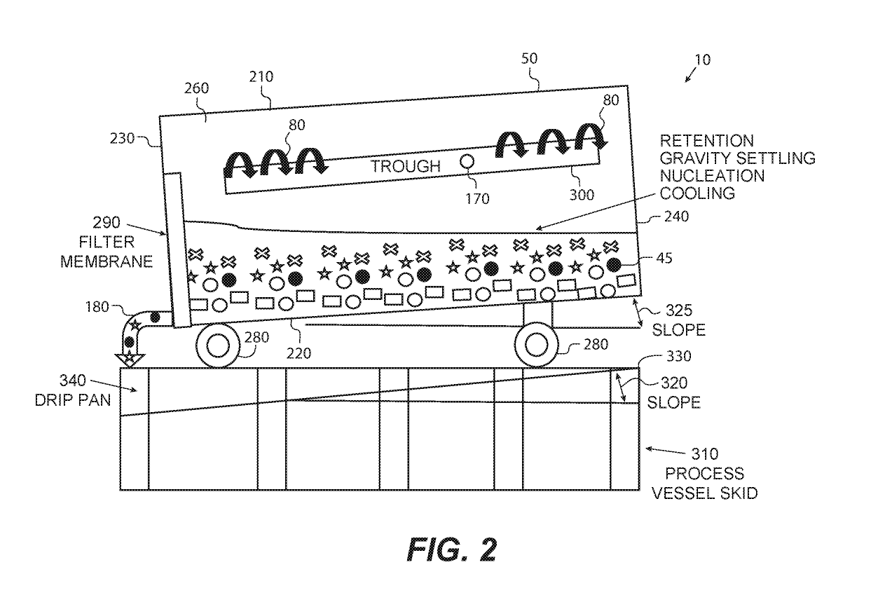

FIG. 3 is a general perspective view illustration of a preferred embodiment of the invention but not depicting an evaporator.

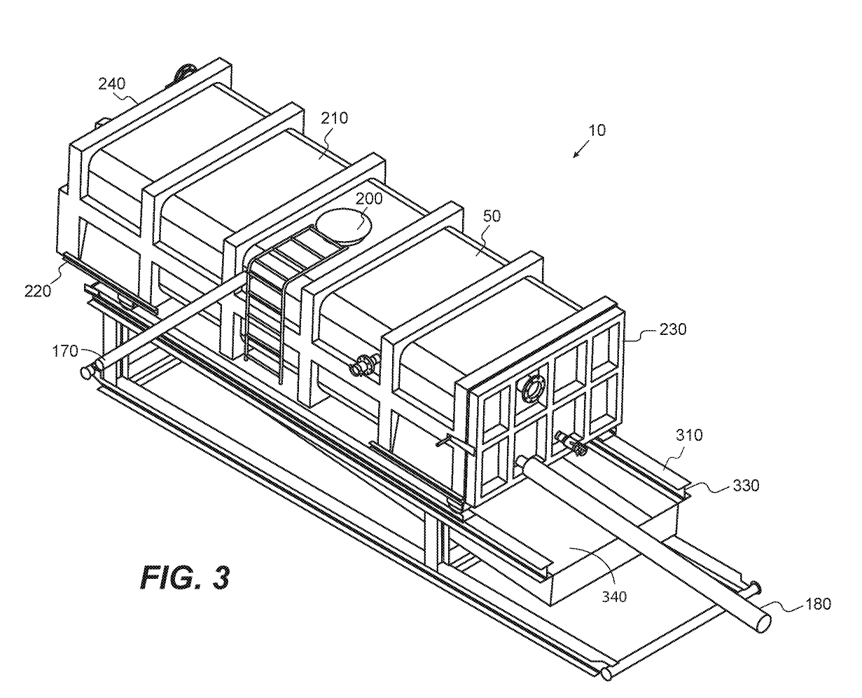

FIG. 4 is general side view illustration of a preferred embodiment of the invention but not depicting an evaporator.

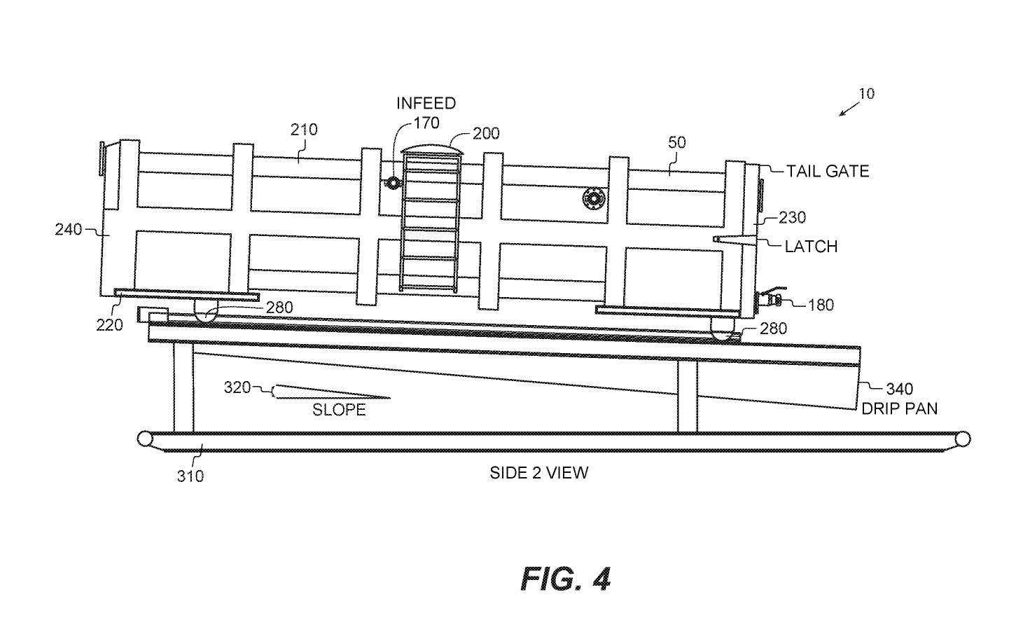

FIG. 5 is a general perspective view illustration with a partial cut away of a preferred embodiment of the invention but not depicting an evaporator.

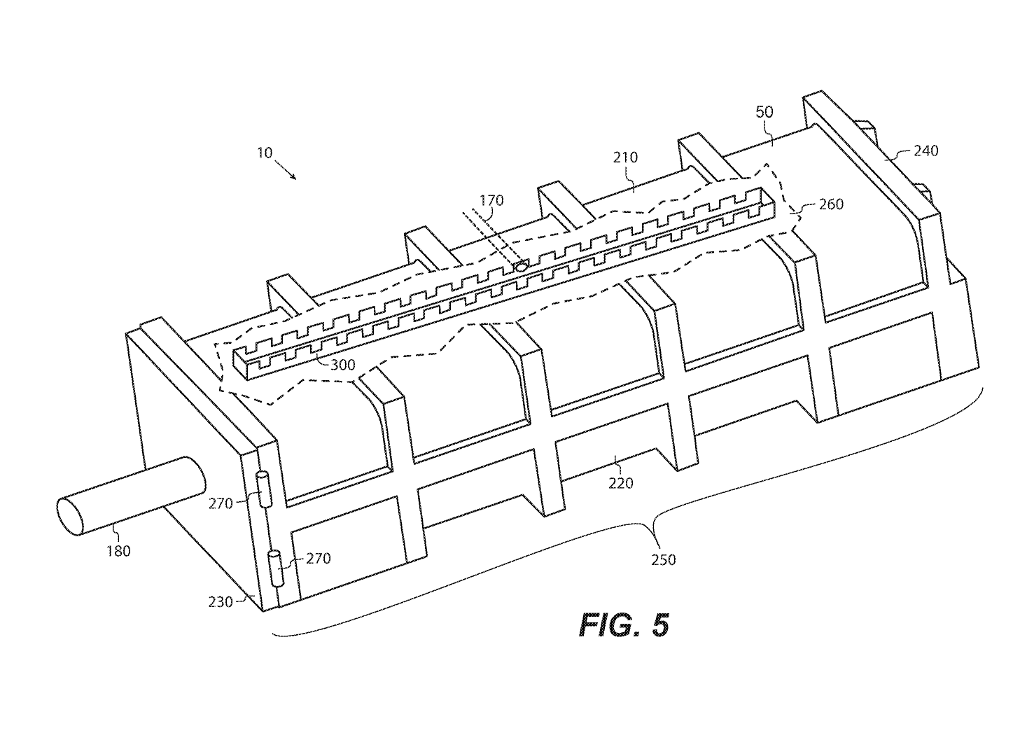

### DETAILED DESCRIPTION OF THE PREFERRED EMBODIMENTS

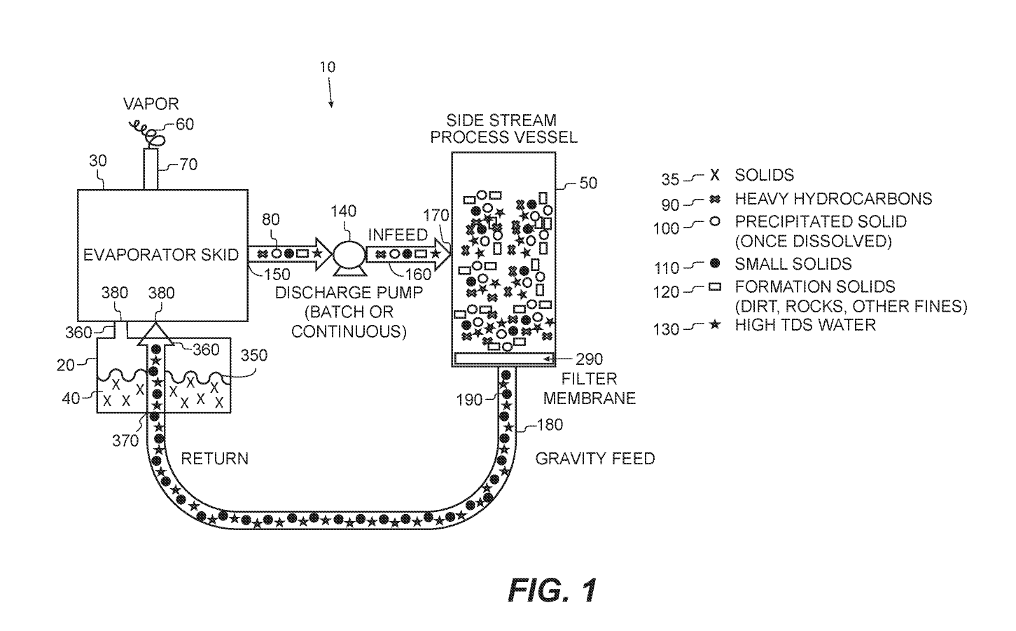

Referring to the illustrations, drawings, and pictures and to FIG. 1 in particular, reference character 10 generally designates a new and improved apparatus, system and method of using same constructed in accordance with the present invention. Invention 10 is generally used with a well utilized for the retrieval of hydrocarbons below the surface. It is understood that invention 10 may be utilized in numerous other applications where it is desirable to treat wastewater and the current invention should not be considered limited to just oil and gas applications. Furthermore, it is also to be understood that the current invention is not limited to flow back water operations, well production, drilling operations, permanent placement and so forth. It is understood that numerous other applications in the oil and gas supply chain are contemplated where it is desirable to treat wastewater by concentrating and or separating solids from liquids. It is therefore understood that the current invention may be utilized with multiple applications.

Invention 10 contemplates providing solids management for a submerged combustion process through solids removal, solids storage, solids dewatering and generally forming a dewater cake to meet landfill requirements and or will pass a paint filter test. Invention 10 contemplates a process that allows continuous or intermittent operation to manage solids such as but not limited to transfer via pressure pumping, separation via gravity, separation via retention, separation via filter media, separation via crystallization caused by temperature change and or transfer via gravity.

Therefore, invention 10 may generally comprise a wastewater source 20 such as but not limited to a holding tank, staging tank, inlet pipe and so forth, an evaporator and or treating tank system 30 for treating influent water and or wastewater 40, a separation tank 50 in communication with evaporator 30. It is contemplated that evaporator 30 may utilize submerged combustion heating for evaporation although it is understood that the current invention is not limited to such. Other forms of wastewater treatment systems known in the art are contemplated to be used in association with the current invention as well as other types of evaporators. Treating tank 30 may be referred to in the specification as evaporator, evaporator tank, evaporation tank, evaporator system and so forth. Separation tank 50 may be referred to in the specification as separator, separator tank, resting tank, separation tank system and so forth. Wastewater source 20 may also be referred to as holding tank, stock tank, staging tank and so forth.

As known in the prior art, submerged combustion heating is generally a method whereby hot products of combustion are forced through a liquid or liquid-solid mixture to heat the liquid or liquid-solid mixture. An advantage of this heating system is that the heat exchange occurs directly between the hot gaseous products of combustion and the liquid. In a submerged combustion system and or evaporator, the hot combustion is typically fuelled by a combination of air and natural gas. Another benefit of such application is the natural gas needed to fuel the evaporation may come from the well operation thereby eliminating the need for transporting a fuel.

In a desalination process, solids 35 such as but not limited to salts, minerals and other various matter are generally dissolved, broken down, burned and or suspended for separating from the wastewater 40. Solids 35 are further discussed below regarding compositions types and the term “solids 35” should not be considered to limit the invention as such and is to be considered to generally refer to solid matter in the wastewater 40.

In a thermal process, as the influent water and or wastewater 40 is heated, the dissolved solids 35 become concentrated and turn into suspended solids 35. After the dissolved solids 35 become suspended, the concentrated solids 35 fall to the bottom of treating tank 30 in which the heat treating occurs, while the free wastewater moves towards the top of treating tank 30 in the form of a vapor 60. The vapor 60 then exits the treating tank 30 through an opening and or aperture 70, most commonly referred to as a stack or an exhaust. To continue the desalination process, the solids 35 eventually must be removed from the treating tank 30.

The output 80 from evaporator 30 that is not in the form of vapor 60 generally comprises heavy hydrocarbons 90, precipitated solids 100 once dissolved, small solids 110, formation solids 120 and high total dissolved solid in water and or liquids 130 also referred to as TDS water. Formation solids 120 may be dirt, rocks and other fines.

To move output 80 from evaporator 30 to separator 50, it is contemplated to utilize a pump 140. In a preferred embodiment, pump 140 may be located on the bottom of coned bottom treating tank 30, stand alone, be attached to separation tank 50, combinations thereof and so forth. It is also contemplated that more than one pump 140 may be utilized. Evaporator 30 may include an outlet and or aperture 150 such that suction end of pump 140 is connected to and or communicates with outlet 150. Invention 10 may include conduit or line 160, which may connect to discharge port of pump 140 to an inlet, opening or aperture 170 of separation tank 50. Pump 140 may be but is not limited to a diaphragm discharge pump equipped with check valves with heavy balls, coated internals and flanged connections.

Another conduit, line, pipe, aperture and or outlet 180 may move output 190 from separation tank 50 back to evaporator 30 as discussed further below. It is also understood that another pump may be utilized but not depicted to move output 190 from separator tank 50 back to evaporator 30 and it is also contemplated that output 190 from separation tank 50 may go to holding tank 20 and combinations thereof.

Separation tank 50 may be configured as a “roll-off” whereby the unit may be rolled on and or off a truck as known in the art. It is also understood that separation tank 50 may be configured to be moved in other various known methods in art and the current invention should not be considered limited to the depictions in the illustrations.

Separation tank 50 may include an access manhole 200, a top 210, a bottom 220, a door and or first end 230, a second end 240, a length 250, an interior 260. It is contemplated that first end 230 may open and use hinge(s) and or hinge system 270 to open door 230 for accessing interior 260. It may further include a wheel(s) and or wheel system 280. Interior 260 may generally have a smooth surface.

It is contemplated that separation tank 50 may further include a filter and or filter membrane 290 for allowing water to pass out of separation tank 50 while retaining larger particulates and solids in general. Filter 290 may be removable, attached to door 230, disposable, made from felt, felt like fabric, other known filter materials and so forth.

Invention 10 contemplates inlet 170 of separation tank 50 may communicate, connect, attach and so forth to trough 300 such that as output 80 from evaporator 30 enters separation tank 50 and is generally dispersed along the length 250 of interior 260. Trough 300 may be of numerous configurations such as but not limited to an open viaduct, closed and or covered viaduct with holes and or apertures along the length and so forth. Trough 300 may be generally horizontally positioned; although it is contemplated, it may be angled inside separation tank 50 as discussed further below.

Invention 10 contemplates resting tank 50 on support structure, platform, and or skid 310. Resting tank 50 may be constructed and or utilized without skid 310. In a preferred construction, resting tank 50 is set at an angle and or slope 320 such that output 190 generally utilizes gravity to move out to the line 180. Angle 320 may be about 5 degrees although greater and lesser angles are also contemplated. It is therefore contemplated that skid 310 may have a top surface 330 that is at an angle to provide angle 320 to resting tank 50. Resting tank 50 may incorporate an angle 325 such that no skid 310 is utilized. Resting tank 50 may include an angled interior surface by example.

It is contemplated that trough 300 is generally angled inside resting tank 50 to reversely correspond with angle 320. This will allow trough 300 to remain generally horizontally positioned while resting tank 50 is set at angle 320. Skid 310 may further include a drip pan 340 for catching liquids and or output 190 from outlet 180.

### In Operation

Invention 10 contemplates that the addition of separation tank 50 increases operational efficiency of evaporator 30 through dilution of the return of output 190 and or water 130 with lower wastewater 40 and converting suspended solids 35 in return output 190 to dissolved form for more efficient evaporation processing. Further, invention 10 allows returning output 190 to heat the wastewater 40 feeding from stock tank 20 to encourage faster evaporation once the wastewater 40 enters the evaporation tank 30.

Separation tank 50 may dewater through crystallization initiated by temperature reduction achieved through tank design, combined with secondary nucleation via interaction with other non-salt solids, combined with gravity achieved through a sloped/angled separation tank design, combined with filter media placed at critical flow points in the separation tanks.

Therefore, invention 10 generally provides that solids 35 from wastewater 40 falls to the bottom of evaporator and or evaporation tank 30 as a result of evaporation such as but not limited to the submerged combustion process and are then removed through the use of a pump 140 from same. The discharge pump 140 may be timed and volume set to operate as needed to manage the volume and consistency of the solids continuously such as but not limited to from 5 gallons per minute to 50 gallons per minute although other amounts greater and lesser are also contemplated.

Solids 35 are then pumped from the discharge pump 140 through outlet 150 pipe or hose able to handle material heated such as but not limited to 200° Fahrenheit into the high temperature discharge pipe or hose to the separation tank 50 via inlet 170. Separation tank 50 may use time, gravity, pressure, filter media, cooling and secondary nucleation to separate free water from the solids 35.

As solids 35 settle to the bottom 220 of separation tank 50, solids 35 may form a cake like substance 45 that generally stays moist enough that it may slide out of separation tank 50 door 230 when door 230 is opened and separation tank 50 is tilted such that gravity allows substance 45 to slide out. It is understood that if substance 45 is too hardened and or dry substance 45 may not slide out as easily. Invention 10 contemplates substance 45 may meet and or exceed landfill requirements as evidenced by the passing of the paint filter test.

TDS water 130 and small solids 110 may then be returned from separation tank 50 to the staging tank and or holding tank 20 via gravity through line and or pipe 180. Pipe 180 may also be referred to as an outlet for separator 50. It is contemplated a pump may be utilized (not depicted). It is also contemplated that line 180 may go to evaporator 30 and combinations thereof. It is also contemplated to provide a lower total dissolved solids water 130 rinse that may be initiated in the return line 180 to prevent scaling.

Staging tank 20 may be designed to isolate the returned suspended solids 35 and may use air percolation 350 to agitate salt in the returned free water 130 to defeat settling and encourage return to circulation into the evaporation process. Returned suspended solids 35 may be isolated within the staging tank 20 to be quickly returned to the evaporation tank 30 via the inlet pump (not depicted) for further processing through the loop.

Holding tank 20 may include an outlet(s) 360 and an inlet 370. Evaporator 30 may have inlet(s) 380.

As needed, when solids 35 and or substance 45 are at the desired level in the separation tank 50, the separation tank 50 may be pulled with existing transportation equipment, transported to a landfill, tilted and emptied through gravity with no secondary clean out process needed. It is understood that clean out may not necessarily require tilting and that other forms of clean out may be utilized.

It is also understood that separation tank 50 may be used in combination with another separation tank 50 or others. One separation tank 50 may be hooked up to evaporator 30 while the other is emptied and so forth. It is also contemplated that evaporator 30 may continuously run while separation tank 50 is removed and then replaced. Separation tank 50 can process and separate solids continuously or intermittently as desired. It is also contemplated to run evaporator 30 and selectively utilize separator 50.

It is therefore contemplated that invention 10 may be wastewater treatment system comprising a holding tank for wastewater wherein said wastewater includes solids therein and wherein said holding tank has an inlet for receiving and an outlet for passing said wastewater; an evaporator for evaporating said wastewater, having an inlet for receiving said wastewater from said holding tank outlet, an outlet for passing said wastewater that is unevaporated and said solids from said wastewater; a separator for separating and collecting said solids from said wastewater, having an inlet for receiving from said evaporator said wastewater that is unevaporated and said solids from said wastewater; and an outlet for passing said wastewater to said holding tank inlet.

Invention 10 evaporator may be a submerged combustion evaporator, the wastewater from a producing oil and gas well, and the evaporator outlet is in communication with a pump for passing said wastewater and said solids to said separator inlet. Still further invention 10 pump may be a diaphragm pump, the separator outlet further includes a filter for filtering said wastewater before passing said wastewater to said holding tank inlet, and the filter is made from fabric.

Invention 10 may include a skid adapted to support said separator at a slope with said separator outlet at the bottom of said slope, the separator is adapted to be utilized as a roll-off for transportation, and the skid further includes a drip pan.

Changes may be made in the combinations, operations, and arrangements of the various parts and elements described herein without departing from the spirit and scope of the invention.

What is claimed is:

1. A wastewater treatment system comprising:
a holding tank for wastewater wherein said wastewater includes solids therein and wherein said holding tank has an inlet for receiving and an outlet for passing said wastewater;
an evaporator for evaporating said wastewater, having an inlet for receiving said wastewater from said holding tank outlet, an outlet for passing said wastewater that is unevaporated and said solids from said wastewater; and
a separator for separating and collecting said solids from said wastewater, having an inlet for receiving from said evaporator said wastewater that is unevaporated and said solids from said wastewater and an outlet for passing said wastewater to said holding tank inlet.

2. The wastewater treatment system of claim 1 wherein said evaporator is a submerged combustion evaporator.

3. The wastewater treatment system of claim 2 wherein said wastewater is from a producing oil and gas well.

4. The wastewater treatment system of claim 3 wherein said evaporator outlet is in communication with a pump for passing said wastewater and said solids to said separator inlet.

5. The wastewater treatment system of claim 4 wherein said pump is a diaphragm pump.

6. The wastewater treatment system of claim 5 wherein said separator outlet further includes a filter for filtering said wastewater before passing said wastewater to said holding tank inlet.

6. The wastewater treatment system of claim 6 wherein said filter is made from fabric.

8. The wastewater treatment system of claim 7 further including a skid adapted to support said separator at a slope with said separator outlet at the bottom of said slope.

9. The wastewater treatment system of claim 8 wherein said separator is adapted to be utilized as a roll-off for transportation.

10. The wastewater treatment system of claim 9 wherein said skid further includes a drip pan.
